(19) United States
(12) Patent Application Publication
(10) Pub. No.: US 2012/0059116 A1
(43) Pub. Date: Mar. 8, 2012

(54) METHOD OF PRODUCING PHENOLATE ESTER COMPOUNDS

(75) Inventors: Stefan Sepeur, Wadgassen (DE); Frank Gross, Saarlouis (DE)

(73) Assignee: NANO-X GMBH, Saarbruecken (DE)

(21) Appl. No.: 13/319,784

(22) PCT Filed: May 4, 2010
(86) PCT No.: PCT/DE2010/000500

§ 371 Date: Nov. 10, 2011

(30) Foreign Application Priority Data
May 14, 2009 (DE) 10 2009 021 388.0

(51) Int. Cl. C09D 183/08; C08G 77/26; B82Y 30/00

(52) U.S. Cl. 524/588; 528/27; 977/773; 977/902

(57) ABSTRACT

The invention relates to phenolic ester compounds.

In order to create a new product class which is suited as coating material, a compound is created within the scope of the invention, having a chemical structure of the following formula:

[R¹—Ph—O]ₐX(R²)_{b}(R³)_{c}(OR)_{n-a-b-c}

where
X=Si, Ti, Zr, Mo, Mn, Cr, W, Hf, Ge, Sn, Pb where n=4 or X=B, V, Al, Ga, In where n=3 or X=Zn, Ni, Cu, alkaline earth where n=2
R¹=O—H, H, O—Y or an organic side chain
Y=an element which is different from or the same as X and has appropriate substituents
R²=alkyl group or functional organic side chain
R³=an organic side chain which is the same as or different from R²
Ph=aryl group
R=alkyl group
   a is an integer between 1 and n; b=0 or 1 and c=0 or 1, and a+b+c=n.

A compound is thus obtained, in which an aryl group is linked into an ester by way of an O—X group. Surprisingly, it was found that materials which resist hydrolysis and are highly stable towards chemicals are obtained by the transesterification of silanes with phenolic compounds.

The invention relates to phenolic ester compounds.

Phenolic resins, epoxy bisphenolic resins and adducts of epoxysilane and bisphenols are known from Stefan Sepeur's thesis “Entwicklung von abriebfesten wasser- und chemikalienbeständigen Beschichtungsmaterialien auf Basis des Sol-Gel-Prozesses für Polymethylmethacrylat (PMMA)” (Development of abrasion proof, water- and chemical-resistant coating materials based on the sol-gel process for polymethylmethacrylate (PMMA)), University of Saarbrücken, Diss., 2001,and “Nanotechnology: Technical Basics and Applications”, Paints and Coatings Edition, by Stefan Sepeur, Nora Laryea, Stefan Goedicke and Frank Groβ, published by Vincentz; 2008.

Polycarbonate, a compound synthesized from phosgene and bisphenol A, is also a common polymer. EP 1 425 332 B1 describes the preparation of polycarbonates from phenols or biphenols.

Cross-linking ensues via the formation of a phenolate ester Ph—O—C(R₁₋₃), where R₁₋₃ is generally hydrogen, another carbon atom, oxygen or nitrogen.

Silanes with hydrolysable groups are known from “Sol-Gel Science: The Physics and Chemistry of Sol-Gel Processing”, J. Brinker, George W. Scherer, C. Jeffrey Brinker, Iten Academic Press, Inc. These silanes are generally methoxysilanes or ethoxysilanes which are able to form inorganic networks following hydrolysis and condensation.

DE 40 30 663 C2 describes a method of electro-dipcoating electrically non-conducting substances, in which a firmly adhering, electrically conducting coating is generated on the substrates by plasmapolymerisation, the coated substrates—after having been dipped into an aqueous, cathodically or anodically precipitable dipping paint—are connected up as cathode or anode, a paint coating is deposited using DC current, the substrates are removed from the electrodeposition paint and the coating is cured.

In the automotive sector, electrochemical dip-coating in the form of cathodic dip-coating (CDC), where the workpiece is coated in an immersion bath, is a familiar, standard procedure. It is well suited for the coating of complex structures and of large numbers of parts. (The process is also known as “cataphoresis”).

Cathodic dip-coating involves depositing the coating by way of chemical conversion of the binder. The fundamental principle of electro-dipcoating consists in precipitating water-soluble binders onto the surface of the workpiece to be coated, which is connected up as electrode, in order to produce a continuous adherent paint film. This is made up of an epoxy resin dispersion and pigment fillers. The coating is applied by means of an electric current flowing from an external electrode (anode), via the electrically conducting paint, to the workpiece (cathode). CDC produces a very even coating on metal surfaces and the interior of hollow parts, with uniform coating thicknesses and good surface qualities.

Electro-dipcoating means that, at the interface, the drops of coating emulsion are destroyed and a layer is formed with the discharged particles.

Electro-dipcoating has the disadvantage that the coatings produced are insufficiently scratch- and abrasion-resistant, necessitating the additional use of of fillers. Another drawback of current electro-dipcoating methods is that contact with the aqueous medium causes the metal pigments in the coating to gas or to become incorporated in such manner in the matrix that cathodic protection is no longer possible.

The object of the invention is thus to create a new product class which is suitable as coating material.

This object is established according to the invention by a compound that has a chemical structure of the following formula or consists of a structure of this type:

[R¹—Ph—O]ₐX(R²)_{b}(R³)_{c}(OR)_{n-a-b-c} (Formula 1)

where
X=Si, Ti, Zr, Mo, Mn, Cr, W, Hf, Ge, Sn, Pb where n=4 or X B, V, Al, Ga, In where n=3 or X=Zn, Ni, Cu, alkaline earth where n=2
R¹=O—H, H, O—Y or an organic side chain
Y=an element which is different from or the same as X and has appropriate substituents
R²=alkyl group or functional organic side chain
R³=an organic side chain which is the same as or different from R²
Ph=aryl group
R=alkyl group
a is an integer between 1 and n; b=0 or 1 and c=0 or 1, and a+b+c=n.

A compound is thus obtained, in which an aryl group (i.e. an aromatic substituent) is linked into an ester by way of an O—X group. If the element X is, for example, silicon, and the aryl group Ph is, for example, a phenyl residue (C₆H₅—), one obtains what is known as a “phenoxy silane ester”, containing a phenyl-O—Si linkage.

Surprisingly, it was found that materials which resist hydrolysis and are highly stable towards chemicals are obtained by the transesterification of silanes with phenolic compounds.

It is within the scope of the invention that the aryl group Ph is part of an organic compound containing phenol, cresol (o-, m-, p-cresol), naphthol (α-, β-naphthol), thymol, pyrocatechol, resorcinol, hydroquinone, 1,4-naphthohydroquinone, phloroglucinol (1,3,5-trihydroxybenzene), lignin, pyrogallol (1,2,3-trihydroxybenzene, hydroxyhydroquinone (1,2,4-trihydroxybenzene), hydroquinone, resorcinol, dihydroxybiphenyl, bis(hydroxyphenyl)alkane, bis(hydroxyphenyl)cycloalkane, bis(hydroxyphenyl)sulfide, bis(hydroxyphenyl)ether, bis(hydroxyphenyl)ketone, bis-(hydroxyphenyl)sulfone, bis(hydroxyphenyl)sulfoxide, a,a′-bis(hydroxyphenyl)diisopropylbenzene and their ring-alkylated or ring-halogenated derivatives, or a,w-bis(hydroxyphenyl)polysiloxane, 4,4′-dihydroxybiphenyl, 2,2-bis(4-hydroxyphenyl)propane (Bisphenol A), 1,1-bis(4-hydroxyphenyl)-3,3,5-trimethylcyclohexane, 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3 -bis[2-(4-hydroxyphenyl)-2-propyl]benzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 2,2-bis-(3,5-dichloro-4-hydroxyphenyl propane or 2,2-bis(3,5-dibromo-4-hydroxyphenyl)propane.

It is also within the scope of the invention that, if the element X is a silicon atom, the silane used for the preparation is selected from the group consisting of aminopropyltriethoxysilane (APTES), aminoethylaminopropyltrimethoxysilane, aminoethylaminopropylsilane, 3-aminopropyltrimethoxysilane (APTMS), N-(2-aminoethyl)-3-amino-propyltrimethoxysilane (DIAMO), N-(2-aminoethyl)-3-aminopropylmethyldimethoxysilane, N-cyclohexyl-3-aminopropyltrimethoxysilane, benzylaminoethylaminopropyltrimethoxysilane, vinylbenzylaminoethylaminopropyltrimethoxysilane, vinyltrimethoxysilane, vinyltriethoxysilane (VTEOS), vinyldimethoxymethylsilane, vinyl(tris)methoxyethoxy)silane, vinylmethoxymethylsilane, vinyltris(2-methoxyethoxy)silane, vinyltriacetoxysilane, 3-glycidoxypropyltrimethoxysilane, 3-glycidoxypropyltriethoxysilane, glycidoxypropylmethyldiethoxysilane, mercaptopropyltrimethoxysilane, bis-triethoxysilylpropyldisulfidosilane, bis-triethoxysilylpropyltetroasulfidosilane, cyclohexylaminomethyldiethoxysilane, N-cyclohexyl-aminomethyltriethoxysilane, N-phenylaminomethyltrimethoxysilane, N-phenylamino-propyltrimethoxysilane, (methacryloxymethyl)methyldimethoxysilane, methacryloxymethyl-trimethoxysilane, (methacryloxymethyl)methyldiethoxysilane, methacryloxymethyltriethoxysilane, 3-methacryloxypropyltrimethoxysilane, 3-methacryloxypropyltriacetoxysilane, (iso-cyanato-methyl)methyldimethoxysilane, 3-isocyanatopropyltrimethoxysilane, (ICTMS) 3-trimethoxysilylmethyl-O-methylcarbamate, N-dimethoxy(methyl)silylmethyl-O-methylcarbamate, 3-(triethoxysilyl)propylsuccinic anhydride, aminopropylmethyldiethoxysilane, aminopropylmethyldimethoxysilane, 1,2-bis(triethoxysilyl)ethane, bis-3-(triethoxypropylsilylpropyl)amine, bis-3-(trimethoxypropylsilylpropyl)amine, butylamino-propyltrimethoxysilane, 2-(3,4-epoxycyclohexyl)ethyltrimethoxysilane, 2-(3,4-epoxycyclohexyl)ethyltriethoxysilane, N-ethyl-3-aminoisobutyltrimethoxysilane, ethyltriacetosilane (ETA), 3-isocyanatopropyltriethoxysilane (ICTES), methyltriacetoxysilane, mercaptopropyltriethoxysilane, mercaptopropyltrimethoxysilane, N-methylaminopropyltrimethoxysilane, 3-(2-(2-aminoethylamino)ethylamino)propyltriethoxysilane (TRIAMO), tris(3-trimethoxysilylpropylisocyanurate), octadecylaminodimethyltrimethoxysilylpropylammonium chloride, chloropropyltrimethoxysilane, 3-chloropropyltriethoxysilane, 3-chloropropyltrimethoxysilane, methyldichlorosilane, trichlorosilane, dimethyldichlorosilane, trimethylchlorosilane, ethyltrichlorosilane, n-propyltrichlorosilane, phenyltrichlorosilane, diphenyldichlorosilane, methylphenyldichlorosilane, 3-chloropropyltrichlorosilane, tetrachlorosilane, methyltrichlorosilane, triethoxy-(3,3,4,4,5,5,6,6,7,7,8,8,8-tridecylfluorooctyl)silane, methyltrimethoxysilane, ethyltrimethoxysilane, n-hexyltrimethoxysilane, n-octyltriethoxysilane, n-octyltrimethoxysilane, propyltrimethoxysilane, propyltriethoxysilane, t-butyltrimethoxysilane, phenyltrimethoxysilane, phenyltriethoxysilane, isobutyltriethoxysilane (IBTEO), isobutyltrimethoxysilane (IBTEO), tetraethoxysilane (TEOS), methyltriethoxysilane (MTEOS), dimethyldimethoxysilane, dimethyldiethoxysilane (DMDES), trimethylethoxysilane, isooctyltrimethoxysilane, isooctyltriethoxysilane, hexadecyltrimethoxysilane, (octadecyl)methyldimethoxysilane, (cyclohexyl)methyldimethoxysilane, dicyclopentyldimethoxysilane or hexadecyltriethoxysilane.

The invention also relates to a method of preparing a phenolate ester compound as described by formula 1, in which a phenolic compound is heated with a silane at temperatures of 60-200° C., preferably 100-150° C., with addition of 0 to 5 wt. % catalysts and elimination of alcohol.

It is to advantage in this connection that the catalysts are selected from the group consisting of acids, bases, Lewis acids, Lewis bases, complexes of titanium, aluminium, tin or zirconium, or other complexes, salts or particles of transition metals, preferably microparticles or nanoparticles.

According to the invention, at least 10 wt. %, preferably at least 25 wt. % or, most preferably, all of the alkoxy groups are transesterified.

It is within the scope of the invention that, if the element X is a silicon atom (X=Si), at least some or all of the alkoxysilane groups (Si-OR groups) are transesterified.

It is expedient that at least 25 mol. %, preferably at least 50% or, most preferably, 100 mol. % of the functional groups are Ph—O—Si linkages.

It is also within the scope of the invention to use a polar or non-polar solvent—in particular an aprotic solvent that is not apt to undergo transesterification—for preparing the ester. Such solvents include, for example, non-polar hydrocarbons such as xylol, hexane and white spirit, or polar acetates such as butyl acetate (BA) or 1-methoxy-2-propylacetate (MPA). Ketones such as methylethyl ketone (MEK) or ethers such as dibutyl ether or tetrahydrofuran are also suitable. If necessary, the solvent may be separated off later by distillation, precipitation or other separating processes.

The scope of the invention furthermore includes use of the compound of the invention as curable coating material that can be applied to a substrate by way of a wet-chemical process, in particular spraying, film casting, flooding, dip coating, spin coating, roll coating or printing.

Use of the compound of the invention as coating material that can be applied to a substrate by means of electrochemical dip-coating is also within the scope of the invention.

Hitherto known sol-gel systems are not suitable for application in an electrophoretic dipcoating bath. The high alcohol content and the low amount of condensate are given as reasons.

Surprisingly, it was found that by way of the following process steps—as are described in the patent specification EP1 355 993 B1 for preparing low-solvent sol-gel systems—siliceous materials, too, can be precipitated in an electrophoretic dipcoating bath:
1. Precipitation of a condensate phase
2. Addition of pigments, in particular corrosion-inhibiting pigments, in particular metallic corrosion-inhibiting pigments,
3. Emulsification in water.

The phenolate ester compound according to this invention can also be precipitated and is thus suitable for use in an electrochemical dip-coating process.

Cathodic dip-coating (CDC) is preferable, although anodic dip-coating is also possible. This form of coating process can thus also be used with sol-gel systems to provide cathodic protection of metallic components and to join identical or different metals with a higher standard potential than that of the coating. It is particularly suitable for the production of corrosion-resistant vehicle components, vehicle body parts and metal components for the furniture and construction industries.

The metals to which preference is given here are from the group consisting of steel, aluminium, magnesium, zinc, aluminium/steel, magnesium/aluminium, magnesium/aluminium/steel and also alloys thereof.

The sol-gel material is produced by hydrolysis and condensation of a silane and/or an alkoxide and/or a plurality of alkoxides and subsequently adding water to the reaction mixture in an amount more than sufficient to cause a phase separation into an aqueous phase and a condensate phase. The condensate phase containing the sol-gel material is then separated off (by precipitation).

It is to advantage if the sol-gel material contains 0 to 90 wt. %, preferably 5 to 30 wt. % or, most preferably, 5 to 20 wt. % (based on the dry, cured coating) corrosion-inhibiting pigments, which are selected from the group consisting of metal pigments, mixtures of metal pigments and metal-alloy pigments or mixtures of metal-alloy pigments.

The corrosion-inhibiting pigments are preferably metal pigments selected from the group consisting of silicon, copper, tin, nickel, zinc, iron, chromium, niobium, vanadium, manganese, aluminium, titanium, beryllium, magnesium, cerium, lanthanum, powders containing sodium, calcium, barium, potassium or lithium, or of mixtures or alloys thereof, which are contained in the dried coating material to an extent of up 90 wt. %, preferably 30 to 90 wt. %, or, most preferably, 40 to 80 wt. %.

In a further embodiment of the invention, the corrosion-inhibiting pigments may also be oxides and salts, in particular phosphates, chromates, acetates or hydroxides, selected from the group consisting of copper-, tin-, nickel-, zinc-, chromium-, niobium-, vanadium-, maganese-, aluminium-, titanium-, beryllium-, magnesium-, cerium-, iron-, lanthanum, sodium-, calcium-, barium-, potassium- and lithium-containing pigments or of mixtures or alloys thereof, which are contained in the dried coating material to an extent of up to 90 wt. %, preferably 30 to 90 wt. % or, most preferably, 40 to 80 wt. %.

The invention also provides for the addition of up to 60 wt. % (based on the solid weight of the sol-gel material) coloured pigments.

In addition, up to 20 wt. %, preferably 0.5 to 10 wt. % (based on the solid weight of the sol-gel material) slip additives or surfactants may be added as emulsifiers.

The dip-coating process and subsequent curing produce a coating with a thickness of 1 to 100 μm, preferably of 5 to 25 μm.

A beneficial refinement of the invention consists in that, following application, the compound is cured at temperatures in the range from room temperature to 250° C., preferably from room temperature to 200° C., curing preferably being effected thermally, by microwave radiation or by UV radiation.

According to the invention, the substrate consists of glass, ceramic, wood, metal, stone, plastic and/or concrete.

The invention is explained in detail below by reference to embodiments.

### EXAMPLE 1 (COATING MATERIAL)

0.4 g methylimidazole are added to 22.8 g bisphenol A (0.1 mol, Fluka) and 47.2 g glycidyloxypropyltrimethoxysilane (0.2 mol, Evonik) and the mixture stirred until all the bisphenol A crystals have dissolved. The solution is heated to 120° C. with simultaneous stirring (reflux condenser, magnetic stirrer, 500 rpm) and kept at this temperature for an hour. The heating is then switched off and the material (which has meanwhile become viscous) left to cool to room temperature. The resultant resin is diluted with 40 g 1-methoxy-2-propanol and mixed with 4.0 g x-add® KR 9006 (NANO-X GmbH, Al initiator) and 0.2 g Byk 301 (Byk-Chemie).

The material is sprayed onto stainless steel and cured for 15 min at 180° C. The dry film thickness may be adjusted to 2 to 40 μm. The coating is highly resistant to 3% potassium hydroxide solution and to 1% sulphuric acid (24 h exposure at room temperature).

### EXAMPLE 2 (POLYMERIC MATERIAL)

0.4 g methylimidazole are added to 22.8 g bisphenol A (0.1 mol, Fluka) and 14.8 g dimethyldiethoxysilane (0.1 mol, ABCR) and the mixture stirred until all the bisphenol A crystals have dissolved. The solution is heated to 120° C. with simultaneous stirring (reflux condenser, magnetic stirrer, 500 rpm) and kept at this temperature for an hour. The internal temperature is subsequently adjusted to 150° C. and the alcohol generated removed with a rotary evaporator. The heating is ultimately switched off and the polymer (which has meanwhile become viscous) left to cool to room temperature until it solidifies. A clear, hard polymer compound forms.

### EXAMPLE 3 (ELECTRODEPOSITION PAINT)

0.8 g methylimidazole are added to 22.8 g bisphenol A (0.1 mol, Fluka) and 55.6 g glycidyloxypropyltriethoxysilane (0.2 mol, Evonik) and the mixture stirred until all the bisphenol A crystals have dissolved. The solution is heated to 120° C. with simultaneous stirring (reflux condenser, magnetic stirrer, 500 rpm) and kept at this temperature for an hour. The heating is then switched off and the material (which has meanwhile become viscous) left to cool to room temperature. Subsequently, the resin is hydrolysed with 5.4 g 5% formic acid (stir for 1 hour at RT, 500 rpm). Then the ethanol that has formed is distilled off together with the formic acid (heating to 100° C. bath temperature for 2 h). 120 g zinc pigment (Eckart Stapa Zinc 4) is dispersed into the cooled reaction product. After addition of 10.0 g Genapol UD 050 emulsifier (Clariant) and homogenisation by stirring, the finished mixture is made up with 800 g de-ionised water and dispersed (stirring).

1-12. (canceled)

13. A method of preparing a compound that has a chemical structure of the following formula:
[R¹—Ph—O]ₐX(R²)_{b}(R³)_{c}(OR)_{n-a-b-c}
where
X=Si, Ti, Zr, Mo, Mn, Cr, W, Hf, Ge, Sn, Pb where n=4 or X=B, V, Al, Ga, In where n=3 or X=Zn, Ni, Cu alkaline earth where n=2
R¹=O—H, H, O—Y or an organic side chain
Y=an element which is different from or the same as X and has appropriate substituents
R²=alkyl group or functional organic side chain
R³=an organic side chain that is the same as or different from R²
Ph=aryl group
R=alkyl group
a is an integer between 1 and n; b=0 or 1 and c=0 or 1, and a+b+c=n,
the aryl group being part of an organic compound containing phenol, cresol (o-, m-, p-cresol), naphthol (α-, β-naphthol), thymol, pyrocatechol, resorcinol, hydroquinone, 1,4-naphthohydroquinone, phloroglucinol (1,3,5-trihydroxybenzene), lignin, pyrogallol (1,2,3-trihydroxybenzene, hydroxyhydroquinone (1,2,4-trihydroxybenzene), dihydroxybiphenyl, bis(hydroxyphenyl)alkane, bis(hydroxyphenyl)cycloalkane, bis(hydroxyphenyl)-sulfide, bis(hydroxyphenyl)ether, bis(hydroxyphenyl)ketone, bis-(hydroxyphenyl)-sulfone, bis(hydroxyphenyl)sulfoxide, a,a′-bis(hydroxyphenyl)diisopropylbenzene and their ring-alkylated or ring-halogenated derivatives, or a,w-bis(hydroxyphenyl)polysiloxane, 4,4′-dihydroxybiphenyl, 2,2-bis(4-hydroxyphenyl)propane (bisphenol A), 1,1-bis(4-hydroxyphenyl)-3,3,5-trimethylcyclohexane, 1,1-bis(4-hydroxyphenyl)-cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3-bis[2-(4-hydroxyphenyl)-2-propyl]benzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)-sulfone, 2,4-bis(3,5-dimethyl-4-hydroxyphenyl)-2-methylbutane, 2,2-bis-(3,5-dichloro-4-hydroxyphenyl propane or 2,2-bis(3,5-dibromo-4-hydroxyphenyl)propane,
a phenolic compound being heated with a silane at temperatures of 60-200° C. with addition of 0.1 to 5 wt. % catalysts, alcohol being eliminated,
and at least 25 mol. % of the functional groups being Ph—O—Si linkages.

14. The method according to claim 13, wherein X is silicon and the Si—O—R group is a component of at least one silane.

15. The method according to claim 14, wherein the silane used for the preparation is selected from the group consisting of aminopropyltriethoxysilane (APTES), aminoethylaminopropyltrimethoxysilane, aminoethylaminopropylsilane, 3-aminopropyltrimethoxysilane (APTMS), N-(2-aminoethyl)-3-amino-propyltrimethoxysilane (DIAMO), N-(2-aminoethyl)-3-aminopropylmethyldimethoxysilane, N-cyclohexyl-3-aminopropyltrimethoxysilane, benzylaminoethylaminopropyltrimethoxysilane, vinylbenzylaminoethylaminopropyltrimethoxysilane, vinyltrimethoxysilane, vinyltriethoxysilane (VTEOS), vinyldimethoxymethylsilane, vinyl(tris)methoxyethoxy)silane, vinylmethoxymethylsilane, vinyltris(2-methoxyethoxy)silane, vinyltriacetoxysilane, 3-glycidoxypropyltrimethoxysilane, 3-glycidoxypropyltriethoxysilane, glycidoxypropylmethyldiethoxysilane, mercaptopropyltrimethoxysilane, bis-triethoxysilylpropyldisulfidosilane, bis-triethoxysilylpropyltetroasulfidosilane, cyclohexylaminomethyldiethoxysilane, N-cyclohexylaminomethyltriethoxysilane, N-phenylaminomethyltrimethoxysilane, N-phenylamino-propyltrimethoxysilane, (methacryloxymethyl)methyldimethoxysilane, methacryloxymethyltrimethoxysilane, (methacryloxymethyl)methyldiethoxysilane, methacryloxymethyltriethoxysilane, 3-methacryloxypropyltrimethoxysilane, 3-methacryloxypropyltriacetoxysilane, (isocyanatomethyl)methyldimethoxysilane, 3-isocyanatopropyltrimethoxysilane, (ICTMS) 3-trimethoxysilylmethyl-O-methylcarbamate, N-dimethoxy(methyl)silylmethyl-O-methyl-carbamate, 3-(triethoxysilyl)propylsuccinic anhydride, aminopropylmethyldiethoxysilane, aminopropylmethyldimethoxysilane, 1,2-bis(triethoxysilyl)ethane, bis-3-(triethoxy-propylsilylpropyl)amine, bis-3-(trimethoxypropylsilylpropyl)amine, butylaminopropyltrimethoxysilane, 2-(3,4-epoxycyclohexyl)ethyltrimethoxysilane, 2-(3,4-epoxycyclohexyl)ethyltriethoxysilane, N-ethyl-3-aminoisobutyltrimethoxysilane, ethyltriacetosilane (ETA), 3-isocyanatopropyltriethoxysilane (ICTES), methyltriacetoxysilane, mercaptopropyltriethoxysilane, mercaptopropyltrimethoxysilane, N-methylaminopropyltrimethoxysilane, 3-(2-(2-aminoethylamino)ethylamino)propyltriethoxysilane (TRIAMO), tris(3-trimethoxysilylpropylisocyanurate), octadecylaminodimethyltri-methoxysilylpropylammonium chloride, chloropropyltrimethoxysilane, 3-chloropropyl-triethoxysilane, 3-chloropropyltrimethoxysilane, methyldichlorosilane, trichlorosilane, dimethyldichlorosilane, trimethylchlorosilane, ethyltrichlorosilane, n-propyltrichlorosilane, phenyltrichlorosilane, diphenyldichlorosilane, methylphenyldichlorosilane, 3-chloropropyltrichlorosilane, tetrachlorosilane, methyltrichlorosilane, triethoxy-(3,3,4,4,5,5,6,6,7,7,8,8,8-tridecylfluorooctyl)silane, methyltrimethoxysilane, ethyl-trimethoxysilane, n-hexyltrimethoxysilane, n-octyltriethoxysilane, n-octyltrimethoxysilane, propyltrimethoxysilane, propyltriethoxysilane, t-butyltrimethoxysilane, phenyltrimethoxysilane, phenyltriethoxysilane, isobutyltriethoxysilane (IBTEO), isobutyltrimethoxysilane (IBTEO), tetraethoxysilane (TEOS), methyltriethoxysilane (MTEOS), dimethyldimethoxysilane, dimethyldiethoxysilane (DMDES), trimethylethoxysilane, isooctyltrimethoxysilane, isooctyltriethoxysilane, hexadecyltrimethoxysilane, (octadecyl)methyldimethoxysilane, (cyclohexyl)methyldimethoxysilane, dicyclopentyldimethoxysilane or hexadecyltriethoxysilane.

16. The method according to claim 13, the phenolic compound being heated with the silane at temperatures of 100-150° C.

17. The method according to claim 16, wherein the catalysts are selected from the group consisting of acids, bases, Lewis acids, Lewis bases, complexes of titanium, aluminum, tin or zirconium, or other complexes, salts or particles of transition metals, preferably microparticles or nanoparticles.

18. The method according to claim 13, wherein at least 50 mol. %, or, most preferably, 100 mol. % of the functional groups are Ph—O—Si linkages.

19. The method according to claim 16, wherein a polar or non-polar solvent is used for preparing the ester, in particular an aprotic solvent that is not apt to undergo transesterification.

20. Use of the method according to claim 13 to prepare coating material that can be applied to a substrate by way of a wet-chemical process, in particular spraying, film casting, flooding, dip coating, spin coating, roll coating or printing.

21. Use of the compound according to claim 13 to prepare coating material that can be applied to a substrate by means of electrochemical dip-coating.

22. Use according to claim 20, wherein following application, the compound is cured at temperatures ranging from room temperature to 250° C., preferably from room temperature to 200° C., curing being effected preferably by heat, microwave radiation or UV radiation.

23. Use according to claim 20, wherein the substrate consists of glass, ceramic, wood, metal, stone, plastic and/or concrete.
